(19) United States
(12) Patent Application Publication
(10) Pub. No.: US 2022/0394582 A1
(43) Pub. Date: Dec. 8, 2022

(54) HYBRID AUTOMATIC REPEAT REQUEST TRANSMISSIONS IN MULTI-LINK DEVICES

(71) Applicant: Cisco Technology, Inc., San Jose, CA (US)

(72) Inventors: Ardalan ALIZADEH, Milpitas, CA (US); Gautam D. BHANAGE, Milpitas, CA (US); Pooya MONAJEMI, San Jose, CA (US); Sivadeep R. KALAVAKURU, Akron, OH (US); Matthew A. SILVERMAN, Shaker Heights, OH (US)

(21) Appl. No.: 17/339,695

(22) Filed: Jun. 4, 2021

(51) Int. Cl. H04W 36/30; H04W 48/20; H04L 1/18

(52) U.S. Cl. CPC H04W 36/305; H04W 48/20; H04L 1/189

(57) ABSTRACT

A method includes transmitting a message over a first link using a first radio of a plurality of radios of a multi-link device and in response to determining that the message was not properly received, selecting a second radio of the plurality of radios of the multi-link device. A second link of the second radio provides a higher probability than the first link that the message will be properly received. The method also includes retransmitting the message over the second link using the second radio.

### TECHNICAL HELD

Embodiments presented in this disclosure generally relate to multi-link devices. More specifically, embodiments disclosed herein relate to hybrid automatic repeat request (HARQ) transmissions in multi-link devices.

### BACKGROUND

HARQ transmissions may be used to help a receiving device assemble or decode a message that was previously received improperly. However, in HARQ, when a message that was improperly received is subsequently retransmitted, the retransmitted message may encounter the same issues that caused the original transmission to be improperly received, which may make it difficult for the receiving device to assemble or decode the message.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example multi-link device of the system of FIG. 1.

FIG. 3 illustrates an example multi-link device of the system of FIG. 1.

FIG. 4 is a flowchart of an example method in the system of FIG. 1.

FIG. 5 is a flowchart of an example method in the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

According to an embodiment, a method includes transmitting a message over a first link using a first radio of a plurality of radios of a multi-link device and in response to determining that the message was not properly received, selecting a second radio of the plurality of radios of the multi-link device. A second link of the second radio provides a higher probability than the first link that the message will be properly received. The method also includes retransmitting the message over the second link using the second radio. Other embodiments include an apparatus that performs this method.

According to another embodiment, a method includes receiving a first message over a first link using a first radio of a plurality of radios of a multi-link device and storing, in a memory, a first log-likelihood ratio value for the first message. The method also includes indicating to a transmitter of the first message that the first message was not properly received and receiving the first message over a second link using a second radio of the plurality of radios of the multi-link device. The method further includes, in response to receiving the first message over the second link, accessing the first log-likelihood ratio value in the memory and receiving a second message over the first link while the first log-likelihood ratio value in the memory is being accessed. The method also includes, in response to receiving the second message, stopping access to the first log-likelihood ratio value in the memory and storing, in the memory, a second log-likelihood ratio value for the second message. Other embodiments include an apparatus that performs this method.

### EXAMPLE EMBODIMENTS

This disclosure describes a multi-link device (e.g., a user device or a network access point) that sends or receives hybrid automatic repeat request (HARQ) transmissions and retransmissions. The multi-link device may send or receive a HARQ retransmission using a radio and link of the multi-link device that is different from the radio and link used to send or receive a previous HARQ transmission that was not received properly. The multi-link device may select a different radio or link because the different radio or link presents a higher probability of a successful transmission or reception. In this manner, the multi-link device may improve the chances that a message will be correctly assembled or decoded using the HARQ transmission and retransmission.

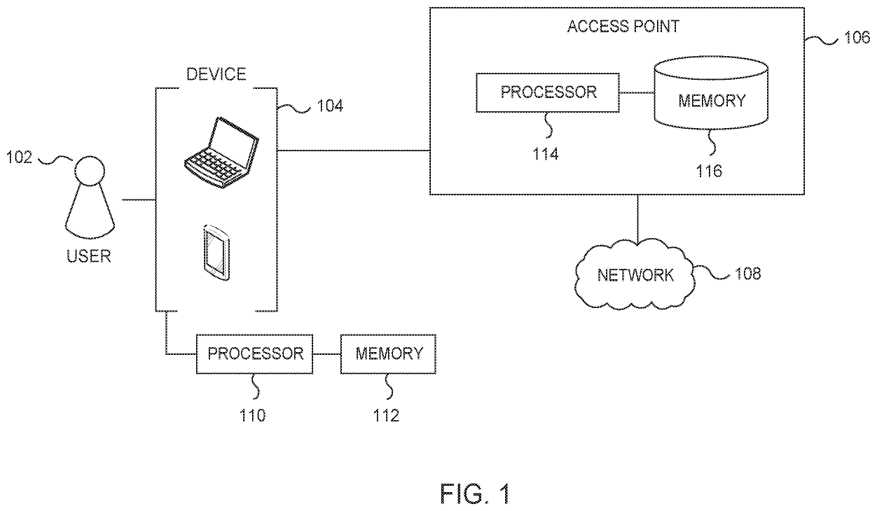

FIG. 1 illustrates an example system 100. As seen in FIG. 1, the system 100 includes one or more devices 104, an access point 106, and a network 108. The one or more devices 104 and/or the access point 106 may be multi-link devices that communicate with each other over different links using different radios. These multi-link devices may send HARQ transmissions and HARQ retransmissions using different links or radios. The devices may select a different radio to perform a HARQ retransmission based on whether the selected link or radio improves the chances, relative to the link or radio that performed the HARQ transmission, that the HARQ retransmission will be received successfully by another device. In this manner, the multi-link device improves the chances that a message will be correctly assembled and/or decoded by a receiving device, in particular embodiments.

A user 102 uses a device 104 to connect to the network 108 via the access point 106. The device 104 establishes a connection with the access point 106, and then communicates messages to and from the access point 106 over this connection. For example, the device 104 may establish a wireless fidelity (WiFi) connection with the access point 106. As seen in FIG. 1, the device 104 includes a processor 110 and a memory 112, which are configured to perform any of the functions or actions of the device 104 described herein.

The device 104 is any suitable device for communicating with components of the system 100. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user 102. The device 104 may include a hardware processor, memory, or circuitry configured to perform any of the functions or actions of the device 104 described herein. For example, a software application designed using software code may be stored in the memory and executed by the processor to perform the functions of the device 104.

The processor 110 is any electronic circuitry, including, but not limited to one or a combination of microprocessors, microcontrollers, application specific integrated circuits (ASIC), application specific instruction set processor (ASID), and/or state machines, that communicatively couples to memory 112 and controls the operation of the device 104. The processor 110 may be 8-bit, 16-bit, 32-bit, 64-bit or of any other suitable architecture. The processor 110 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 110 may include other hardware that operates software to control and process information. The processor 110 executes software stored on the memory 112 to perform any of the functions described herein. The processor 110 controls the operation and administration of the device 104 by processing information (e.g., information received from the access point 106, network 108, and memory 112). The processor 110 is not limited to a single processing device and may encompass multiple processing devices.

The memory 112 may store, either permanently or temporarily, data, operational software, or other information for the processor 116. The memory 112 may include any one or a combination of volatile or non-volatile local or remote devices suitable for storing information. For example, the memory 112 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 112, a disk, a CD, or a flash drive. In particular embodiments, the software may include an application executable by the processor 110 to perform one or more of the functions described herein.

The access point 106 facilitates communication between the one or more devices 104 and the network 108. The access point 106 establishes connections with the one or more devices 104 and then communicates messages to and from the one or more devices 104 over the connection. As seen in FIG. 1, the access point 106 includes a processor 114 and a memory 116, which are configured to perform any of the functions or actions of the access point 106 described herein.

The processor 114 is any electronic circuitry, including, but not limited to one or a combination of microprocessors, microcontrollers, application specific integrated circuits (ASIC), application specific instruction set processor (ASID), and/or state machines, that communicatively couples to memory 116 and controls the operation of the access point 106. The processor 114 may be 8-bit, 16-bit, 32-bit, 64-bit or of any other suitable architecture. The processor 114 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 114 may include other hardware that operates software to control and process information. The processor 114 executes software stored on the memory 116 to perform any of the functions described herein. The processor 114 controls the operation and administration of the access point 106 by processing information (e.g., information received from the devices 104, network 108, and memory 116). The processor 114 is not limited to a single processing device and may encompass multiple processing devices.

The memory 116 may store, either permanently or temporarily, data, operational software, or other information for the processor 114. The memory 116 may include any one or a combination of volatile or non-volatile local or remote devices suitable for storing information. For example, the memory 116 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 116, a disk, a CD, or a flash drive. In particular embodiments, the software may include an application executable by the processor 114 to perform one or more of the functions described herein.

The network 108 is any suitable network operable to facilitate communication. The network 108 may include any interconnecting system capable of transmitting audio, video, signals, data, messages, or any combination of the preceding. The network 108 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The device 104 and/or the access point 106 may implement HARQ, so that the device 104 and/or the access point 106 may retransmit messages that were not received properly by a receiving device. The receiving device may indicate to the transmitting device that a transmitted message contained errors or was otherwise not received properly. The transmitting device may then retransmit the message. The receiving device maintains the previous transmissions of the message and uses these previous transmissions along with the current retransmission to attempt to assemble or decode the message, even though the previous transmissions and the retransmission may include errors and/or not be received properly. The receiving device may nevertheless assemble or decode the message based on the previous transmissions and retransmission of the message that includes errors. In this manner, the receiving device can properly receive the message, even though none of the transmissions or retransmissions were received properly.

As discussed previously, the one or more devices 104 and/or the access point 106 may be multi-link devices that communicate over multiple links using multiple radios. The multi-link devices may establish different links using these different radios over different bands and different channels. In some embodiments; these multi-link devices may communicate simultaneously with each other over these different links. For example, if the device 104 and the access point 106 are both multi-link devices; the device 104 and the access point 106 may communicate with each other over multiple links simultaneously. The device 104 may transmit messages to the access point 106 over one link while the access point 106 transmits messages to the device 104 over another link.

The multi-link devices may communicate a HARQ transmission over a first link using the first radio and then select a different; second link and a different, second radio to perform a HARQ retransmission, when the receiving device indicates that the HARQ transmission was not received properly. The multi-link device may select the second link or second radio in response to determining that the second link or second radio provides a better chance of the HARQ retransmission being received properly by the receiving device. For example, the second link or second radio may have a higher signal strength than the first link or first radio used for the HARQ transmission. As another example, the second link or second radio may have a lower frequency than the first link or first radio used for the HARQ transmission. In this manner, the multi-link device improves the chances that the receiving device will receive the HARQ retransmission properly. Additionally, the mufti-link device improves the chances that the receiving device will be able to assemble or decode the transmitted message, in particular embodiments.

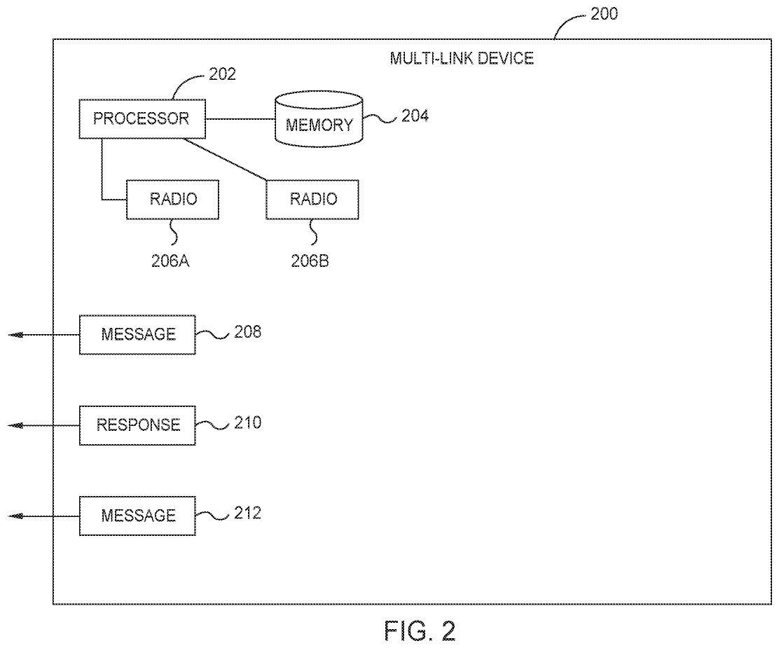

FIG. 2 illustrates an example multi-link device 200 of the system 100 of FIG. 1. As discussed previously, the mufti-link device 200 may be a device 104 or access point 106. As seen in FIG. 2, the multi-link device 200 includes a processor 202, a memory 204, and radios 206A and 2068, which are configured to perform any of the functions or actions of the multi-link device 200 described herein. The processor 202 may be the processor 110 of the device 104 or the processor 114 of the access point 106. The memory 204 may be the memory 112 of the device 104 or the memory 116 of the access point 106.

The multi-link device 200 may include any suitable number of radios 206. In particular embodiments, the multi-link device 200 performs a HARQ transmission using the radio 206A and then selects the radio 206B to perform the HARQ retransmission. The multi-link device 200 may perform the HARQ retransmission when there is an indication that the HARQ transmission was not received properly. In this manner, the multi-link device 200 improves the chances that the HARQ retransmission will be received properly, in particular embodiments. Additionally, the multi-link device 200 improves the chances that the receiving device will be able to assemble or decode the message based on the HARQ transmission and the HARQ retransmission, in particular embodiments.

The radios 206 are communicatively coupled to the processor 202. The processor 202 uses the radios 206 to transmit and receive messages from another device. The radios 206 operate over different bands and different channels. For example, the radio 206A may use a frequency that is different from the radio 206B. In some embodiments, the radios 206A and 2068 are WiFi radios that communicate over different bands such as the 2.4 gigahertz band and the 5 gigahertz band. The multi-link device 200 may establish links simultaneously using the radios 206A and 206B. The multi-link device 200 may then communicate messages over both links simultaneously. For example, if the multi-link device 200 was the access point 106 in the system 100, then the access point 106 may use the radios 206A and 2068 to establish two links with a device 104 simultaneously. The access point 106 may then transmit messages to the device 104 over one link using the radio 206A while receiving messages from the device 104 over the other link using the radio 206B. In this manner, the multi-link device 200 increases message throughput, in particular embodiments.

The multi-link device 200 performs a HARQ transmission by transmitting a message 208 using one of the radios 206A or 206B. For example, the multi-link device 200 may transmit the message 208 over a link established using the radio 206A. Due to errors in the link, the message 208 may not be received properly at the receiving device. For example, parts of the message 208 may not be received at all by the receiving device. As another example, portions of the message 208 may be received incorrectly such that certain bits within the message 208 are flipped. The receiving device may analyze the message 208 to determine that the message 208 was not received properly. The receiving device communicates a response 210 to the multi-link device 200 to indicate whether the message 208 was received properly. For example, the response 210 may be an acknowledgement, which indicates to the multi-link device 200 that the message 208 was received properly, or a negative acknowledgment, which indicates to the multi-link device 200 that the message 208 was not received properly.

The multi-link device 200 analyzes the response 210 to determine that the message 208 was not received properly. In response, the multi-link device 200 performs a HARQ retransmission. The multi-link device 200 may select a different link and/or a different radio 206 to perform the HARQ retransmission. Using the example of FIG. 2, the multi-link device 200 may select the radio 206B to perform the HARQ retransmission. The multi-link device 200 then transmits the message 212 over the link established using the radio 206B. The message 212 may effectively be the same as the message 208. For example, the message 212 may carry the same payload as the message 208. The receiving device may attempt to assemble or decode the original message 208 using the HARQ transmission and the HARQ retransmission. In this manner, even if the HARQ retransmission is not received properly by the receiving device, the receiving device may still nevertheless determine the original message 208, based on the improperly received HARQ transmission and the improperly received HARQ retransmission.

The mufti-link device 200 may select the radio 2068 to transmit the message 212 in response to determining that the radio 206B provides a higher chance that the HARQ retransmission will be received properly by the receiving device. For example, the multi-link device 200 may determine that the link established using the radio 206B provides a higher signal strength than the link established using the radio 206A. In response, the multi-link device 200 selects the radio 206B to perform the HARQ retransmission. The multi-link device 200 then transmits the message 212 over the link established using the radio 206B.

As another example, the mufti-link device 200 may determine that the radio 206B transmits at a lower frequency than the radio 206A. In some embodiments, transmissions at a lower frequency may provide a higher signal strength, and thus, improve the chances that a transmitted message will be received properly. In response to determining that the radio 206B is transmitting at a lower frequency than the radio 206A, the multi-link device 200 selects the radio 206B to perform the HARQ retransmission. The multi-link device 200 then uses the radio 206B to transmit the message 212 to the receiving device.

As another example the multi-link device 200 may analyze the antenna patterns of the radios 206A and 206B. The multi-link device 200 may determine, based on the antenna pattern of the radio 206B, that the radio 206B provides a higher chance of the HARQ retransmission being received properly by the receiving device. In response, the multi-link device 200 selects the radio 206B to perform the HARQ retransmission. The multi-link device 200 then transmits the message 212 using the radio 206B.

As another example, the multi-link device 200 may determine that the radio 206B has a better radio frequency gain than the radio 206A. The higher radio frequency gain may provide a better chance for the HARQ retransmission to be received properly by the receiving device. In response, the multi-link device 200 selects the radio 206B to perform the HARQ retransmission. The multi-link device 200 then transmits the message 212 using the radio 206B.

As yet another example, the mufti-link device 200 may determine that the radio 206B has a better deep fading threshold than the radio 206A. The better deep fading threshold may provide a higher chance of the HARQ retransmission being received properly by the receiving device. In response, the multi-link device 200 selects the radio 206B to perform the HARQ retransmission. The multi-link device 200 than transmits the message 212 using the radio 206B.

In some embodiments, the receiving device may communicate a request to the multi-link device 200 to select a particular radio 206 for performing the HARQ retransmission. For example, the receiving device may include, in the response 210, a request indicating that the radio 206B should be selected for the HARQ retransmission. In response, the multi-fink device 200 selects the radio 206E to perform the HARQ retransmission. The multi-link device 200 then communicates the message 212 using the radio 206B. In some embodiments, the receiving device generates the request in response to determining that the link established using the radio 206B provides a higher likelihood of carrying messages properly. The receiving device then communicates the request within the response 210 to the multi-link device 200. In this manner, the multi-link device 200 is not responsible for deciding which radio 206 to use for the HARQ retransmission.

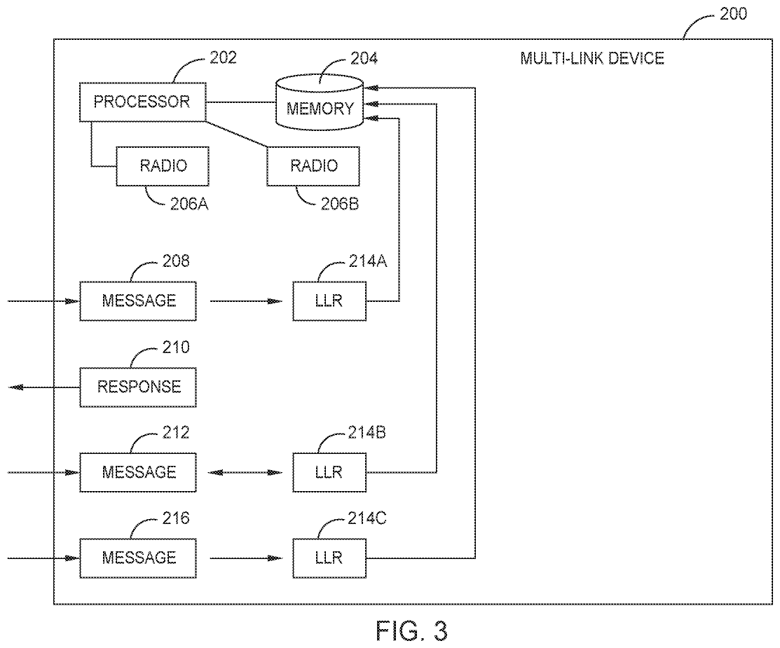

FIG. 3 illustrates an example multi-link device 200 of the system 100 of FIG. 1. In the example of FIG. 3, the multi-link device 200 operates as the receiving device for the HARQ transmission and the HARQ retransmission. As discussed previously, the multi-link device 200 may be the device 104 or the access point 106 in the system 100 of FIG. 1.

The multi-link device 200 receives the message 208. The mufti-link device 200 may have received the message 208 over a link established using the radio 206A. Due to issues in the link or the channel, the multi-link device 200 may not receive the message 208 properly. For example, part of the message 208 may be missing. As another example, certain bits in the message 208 may be flipped. The multi-link device 200 analyzes the message 208 to determine that the message 208 was not received properly. For example, the multi-link device 200 may determine that the message 208 is shorter than the message 208 should be. As another example, the multi-link device 200 may perform error checking to determine that certain bits within the message 208 were flipped.

The multi-link device 200 generates a log likelihood ratio (LLR) 214 based on the message 208. The LLR 214 expresses or indicates the probabilities that certain bits within the message 208 are correctly received or incorrectly received. The multi-link device 200 stores the LLR 214 in the memory 204 for later use. The multi-link device 200 uses the LLR 214 to subsequently assemble or decode the message 208 in conjunction with HARQ transmissions and HARQ retransmissions.

The multi-link device 200 generates and communicates the response 210 to a transmitting device. The response 210 indicates that the message 208 was not received properly. For example, the response 210 may be a negative acknowledgment that indicates the message 208 was either not received completely or was received with error. In response to the negative acknowledgement, the transmitting device performs a HARQ retransmission. In some embodiments, the transmitting device may select a different radio 206 to perform the HARQ retransmission. For example, the transmitting device may perform the HARQ retransmission over a link established using the radio 206B.

The multi-link device 200 may receive the message 212 representing the HARQ retransmission over the link established using the radio 206B. The multi-link device 200 then analyzes the message 212 to determine if the message 212 was received properly. For example, the multi-link device 200 may determine if the message 212 was received completely or if certain bits in the message 212 are flipped. If the message 212 was not received properly, the multi-link device 200 generates an LLR 214B that expresses or represents the probabilities that certain bits within the message 212 were received properly.

The multi-link device 200 may then attempt to assemble or decode the original message 208 using the HARQ transmission, the HARQ retransmission, and the LLR's 214A and 214B. If the multi-link device 200 can assemble or decode the original message 208, the multi-link device 200 may communicate a response 210 to the transmitting device that the original message 208 has been received properly. If the multi-link device 200 cannot assemble or decode the original message 208 based on the HARQ transmission, the HARQ retransmission, and the LLR's 214A and 214B, then the multi-link device 200 may communicate a response 210 to the transmitting device indicating that the original message 208 has not been received properly. The transmitting device may then perform another HARQ retransmission and the multi-link device 200 may then attempt again to assemble or decode the original message 208 based on the HARQ transmission, the HARQ retransmission, the second HARQ retransmission, and their associated LLR's 214. This process may continue until the multi-link device 200 indicates that the original message 208 was received properly.

Because the multi-link device 200 may use different radios 206 to receive HARQ transmissions and HARQ retransmissions, memory collisions in the memory 204 may occur (e.g., when the multi-link device 200 is accessing and/or storing LLR's 214 in the memory 204 for one radio 206 when another memory operation for another radio 206 is needed). For example, if the multi-link device 200 receives a message 216 and then determines that the message 216 was not received properly, the multi-link device 200 generates an LLR 214C for the message 216 and then stores the LLR 214C in the memory 204. If the message 216 was received using the first radio 206A while the memory 204 is being accessed for the LLR 214A, then a memory collision occurs. The multi-link device 200 may resolve these memory collisions by prioritizing certain memory operations based on the LLR's 214 and their corresponding messages.

For example, the mufti-link device 200 may determine that the message 216 is larger than the message 208. In response to the message 216 being the larger message, the multi-link device 200 may stop access to the LLR 214A or 214B to allow the storage of the LLR 214C into the memory 204. In this manner, the multi-link device 200 prioritizes the reception, assembly, or decoding of larger messages.

As another example, the multi-link device 200 may determine that the link established using the radio 206B has a higher signal strength than the link established using the radio 206A. In response, the multi-link device 200 stops access to the LLR 214A or 2143 in the memory 204, so that the LLR 214C can be stored in the memory 204. The multi-link device 200 may determine that the higher signal strength for the radio 206B may result in the message 216 having a lower likelihood of being received properly. In response, the multi-link device 200 may store the LLR 214C in the memory 204, so that the HARQ retransmissions for the message 216 may be quickly performed. In this manner, the multi-link device 200 prioritizes the weaker radio 206.

In some embodiments, by stopping access to the memory 204 for the LLR's 214A or 2148 and by granting access to the memory 204 to store the LLR 214C, the multi-link device 200 prioritizes the messages that have a lower likelihood of being received properly, so that HARQ retransmissions for those messages may be performed quickly. After the LLR 214C has been stored in the memory 204, the multi-link device 200 may grant access back to the memory 204 to access the LLR's 214A or 214B.

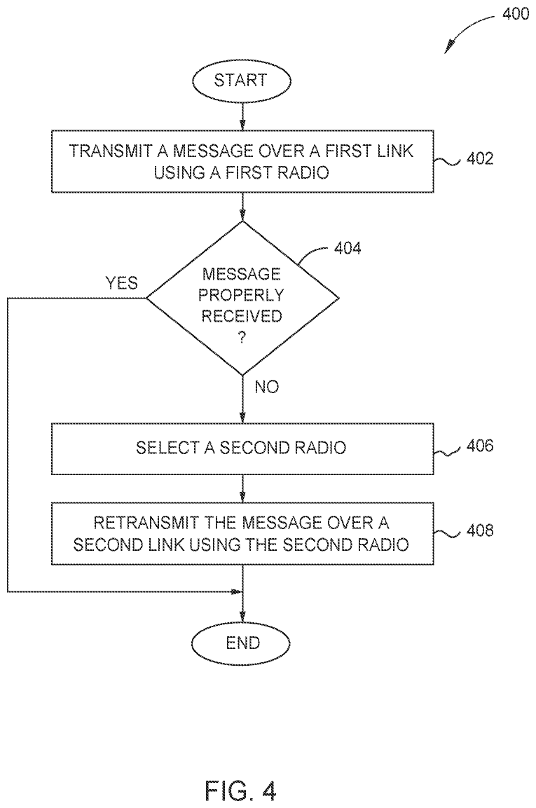

FIG. 4 is a flowchart of an example method 400 in the system 100 of FIG. 1. A multi-link device 200 (e.g., the device 104 or the access point 106) may perform the method 400. In particular embodiments, by performing the method 400, the multi-link device 200 improves the chances that a HARQ retransmission will be received properly by a receiving device. Additionally, the multi-link device 200 improves the chances that the receiving device will be able to assemble or decode a message based on the HARQ retransmission, in certain embodiments.

In block 402, the multi-link device 200 performs a HARQ transmission by transmitting a message 208 over a first link using a first radio 206A. In block 404, the multi-link device 200 determines whether the message 208 was properly received by a receiving device. The multi-link device 200 may determine whether the message 208 was properly received based on a response 210 communicated by the receiving device. If the response 210 is an acknowledgment, then the multi-link device 200 determines that the message 208 was received properly and concludes the method 400. If the response 210 is a negative acknowledgment, then the multi-link device 200 determines that the message 208 was not properly received.

In block 406, the multi-link device 200 selects a second radio 206B for performing a HARQ retransmission. The mufti-link device 200 may select the second radio 206B because the second radio 206B provides a higher probability that the HARQ retransmission will be received properly by the receiving device. For example, the multi-link device 200 may select the second radio 206B, because the second radio 206B has a higher signal strength than the first radio 206A. As another example, the multi-link device 200 may select the second radio 206B, because the second radio 206B transmits at a lower frequency than the first radio 206A. As yet another example, the mufti-link device 200 may select the second radio 206B, because the response 210 includes a request to select the second radio 206B for the HARQ retransmission. The receiving device may have generated the request to indicate to the multi-link device 200 that the second radio 206B should be selected. As yet another example, the multi-link device 200 may select the second radio 206B based on at least one of an antenna pattern, a radio frequency gain, and/or a deep fading threshold of the second radio 206B.

In block 408 the multi-link device 200 performs the HARQ retransmission using the second radio 206B. Specifically, the multi-link device 200 transmits the message 212 over a second link using the second radio 206B. The message 212 may effectively be the same as the message 208B in that the message 212 includes the same payload as the message 208.

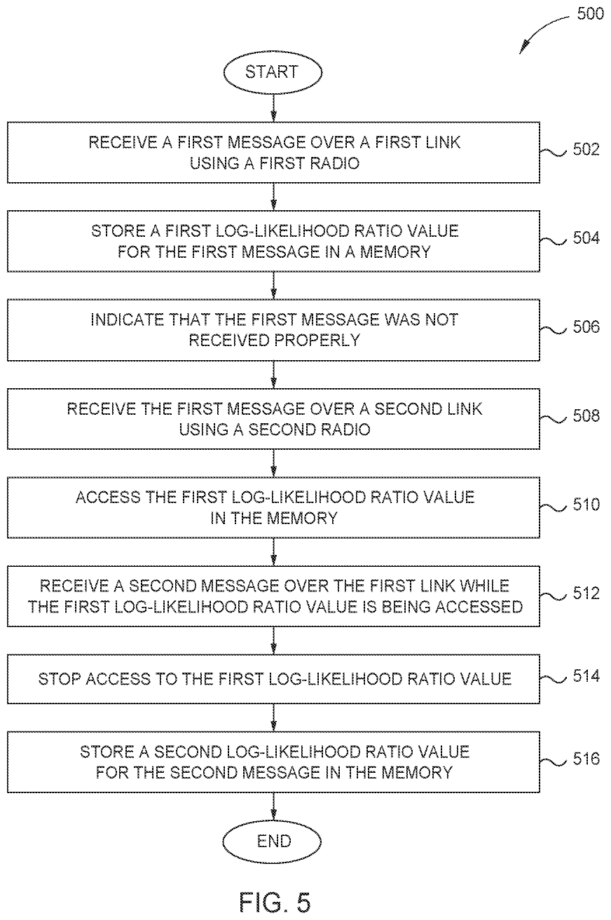

FIG. 5 is a flowchart of an example method in the system 100 of FIG. 1. A multi-link device 200 (e.g., the device 104 or the access node 106) may perform the method 500. In particular embodiments, by performing the method 500, the multi-link device 200 resolves memory collisions when receiving HARQ retransmissions over different radios 206.

In block 502, the multi-link device 200 receives a first message 208 over a first link using a first radio 206A. The multi-link device 200 may determine that the first message 208 was not received properly. For example, the multi-link device 200 may determine that the message 208 is incomplete or that certain bits of the message 208 have been flipped. In block 504, the multi-link device 200 stores a first LLR 214A for the first message 208 in a memory 204. The LLR 214A indicates or expresses probabilities that bits within the message 208 were received properly. The mufti-link device 200 may use the LLR 214A to assemble or decode the message 208 after HARQ retransmissions have been received.

In block 506, the multi-link device 200 indicates that the first message 208 was not received properly. The multi-link device 200 generates and communicates a response 210 to a transmitting device to indicate that the message 208 was not received properly. For example, the multi-link device 200 may generate a negative acknowledgment and communicate the negative acknowledgment to the transmitting device to indicate that the message 208 was not received properly. In block 508, the mufti-link device 200 receives a HARQ retransmission over a second link using a second radio 206B. The transmitting device may have performed the HARQ retransmission in response to the response 210 communicated by the multi-link device 200.

In block 510, the multi-link device 200 attempts to assemble or decode the first message 208 based on the HARQ retransmission. The mufti-link device 200 accesses the first LLR 214A in the memory 204 so that the mufti-link device 200 can use the first LLR 214A to assemble or decode the first message 208.

While the multi-link device 200 is accessing the first LLR 214A in the memory 204, the multi-link device 200 receives a second message 216 over the first link using the first radio 206A in block 512. The multi-link device 200 may determine that the second message 216 was not received properly. As a result, the mufti-link device 200 may need to generate and store a LLR 214C for the second message 216. In block 514, the mufti-link device 200 stops access to the first LLR 214A in the memory 204. In block 516, the multi-link device 200 stores the second LLR 214C for the second message 216 into the memory 204. By stopping access to the first LLR 214A before storing the second LLR 214C into the memory 204, the multi-link device 200 prevents a collision in the memory 204. In certain embodiments, the multi-link device 200 determines that the second LLR 214C should be prioritized over the first LLR 214A in response to determining that the second message 216 has a greater size than the first message 208. In some embodiments, the multi-link device 200 prioritizes the second LLR 214C in response to determining that the second link using the second radio 206B has a better signal strength than the first link using the first radio 206A. In this manner, the multi-link device 200 may allow for HARQ retransmissions to occur over different links using different radios 206 while avoiding memory collisions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
transmitting a message over a first link using a first radio of a plurality of radios of a mufti-link device;
in response to determining that the message was not properly received, selecting a second radio of the plurality of radios of the multi-link device, wherein a second link of the second radio provides a higher probability than the first link that the message will be properly received; and
retransmitting the message over the second link using the second radio.

2. The method of claim 1, further comprising receiving a request to retransmit the message, wherein the second radio is selected further in response to the request.

3. The method of claim 1, wherein the second radio is selected further in response to the second link having a signal strength higher than a signal strength of the first link.

4. The method of Claire 3, wherein the second radio transmits at a lower frequency than the first radio.

5. The method of claim 1, wherein the second radio is selected based on an antenna pattern of the second radio.

6. The method of claim 1, wherein the second radio is selected based on a radio frequency gain of the second radio.

7. The method of claim 1, wherein the second radio is selected based on a deep fading threshold of the first radio.

8. A method comprising:
receiving a first message over a first link using a first radio of a plurality of radios of a multi-link device;
storing, in a memory, a first log-likelihood ratio value for the first message;
indicating to a transmitter of the first message that the first message was not properly received;
receiving the first message over a second link using a second radio of the plurality of radios of the multi-link device;
in response to receiving the first message over the second link, accessing the first log-likelihood ratio value in the memory;
receiving a second message over the first link while the first log-likelihood ratio value in the memory is being accessed;
in response to receiving the second message:
stopping access to the first log-likelihood ratio value in the memory; and
storing, in the memory, a second log-likelihood ratio value for the second message.

9. The method of claim 8, wherein stopping access to the first log-likelihood ratio value in the memory is further in response to a size of the second message exceeding a size of the first message.

10. The method of claim 8, wherein stopping access to the first log-likelihood ratio value in the memory is further in response to the second link having a signal strength higher than a signal strength of the first link.

11. The method of claim 8, further comprising decoding the first message using the first log-likelihood ratio value.

12. The method of claim 8, wherein the second link provides a higher probability than the first link that the first message will be properly received.

13. The method of claim 8, wherein the second radio is selected based on a radio frequency gain of the second radio.

14. The method of claim 8, wherein the second radio is selected based on a deep fading threshold of the first radio.

15. An apparatus comprising:
a memory; and
a hardware processor communicatively coupled to the memory, the hardware processor configured to:
transmit a message over a first link using a first radio of a plurality of radios of a multi-link device;
in response to determining that the message was not properly received, select a second radio of the plurality of radios of the multi-link device, wherein a second link of the second radio provides a higher probability than the first link that the message will be properly received; and
retransmit the message over the second Ink using the second radio.

16. The apparatus of claim 15, wherein the hardware processor is further configured to receive a request to retransmit the message, wherein the second radio is selected further in response to the request.

17. The apparatus of claim 15, wherein the second radio is selected further in response to the second link having a signal strength higher than a signal strength of the first link.

18. The apparatus of claim 17, wherein the second radio transmits at a lower frequency than the first radio.

19. The apparatus of claim 15, wherein the second radio is selected based on an antenna pattern of the second radio.

20. The apparatus of claim 15, wherein the second radio is selected based on a radio frequency gain of the second radio.
